(19) United States
(12) Patent Application Publication
(10) Pub. No.: US 2002/0156850 A1
(43) Pub. Date: Oct. 24, 2002

(54) Negotiating agreements

(76) Inventors: Walter Hamscher, Concord, MA (US); David Urry, North Andover, MA (US); Sarah Meyer, Newton, MA (US)

Correspondence Address: DAVID L. FEIGENBAUM, Fish & Richardson P.C., 225 Franklin Street, Boston, MA, 02110-2804, US

(21) Appl. No.: 09/841,184

(22) Filed: Apr. 24, 2001

(51) Int. Cl. G06F 15/16

(52) U.S. Cl. 709/205; 709/206

(57) ABSTRACT

A commercial transaction, e.g., the purchase and sale of an item of capital equipment, is negotiated using a communication network, e.g., the Internet.

### TECHNICAL FIELD

This application relates to U.S. patent application Ser. No. 09/489,197, filed on Jan. 20, 2000, and incorporated by reference.

This invention relates to negotiating agreements.

### BACKGROUND

Commercial transactions, such as the purchase and sale of used capital equipment, generally require detailed negotiation. A variety of terms must be negotiated and agreed upon, such as financing, delivery terms, and technical specifications. It is usually necessary to involve third party providers of services, such as shipping and financing. As a result, such transactions are often time-consuming, lengthy and complex, and involve many interactions between the buyer and seller leading ultimately to a signing of a written agreement containing language that captures the specifically negotiated terms and typically some standard “canned” terms. Moreover, it may be difficult for a new-comer to an industry, or a company in a developing country, to make the contacts necessary to enter into such a transaction. In international transactions, time-zone differences, language barriers, and additional terms relating to import/export issues exacerbate these difficulties.

Some websites allow goods to be purchased in simple consumer transactions, e.g., the un-negotiated purchase of plane tickets or consumer goods or use of an “auction model”.

### SUMMARY

Other features and advantages of the invention will be apparent from the description and drawings, and from the claims.

In general, in one aspect, the invention features a method that includes enabling a first party to a possible transaction to invoke an element of a user interface to cause electronic mail invitations to be sent to selected individuals who will form a team representing the first party in connection with the transaction. mail invitations to be sent to selected individuals who will form a team representing the first party in connection with the transaction.

Implementations of the invention may include (a) enabling the first party to invoke an element of a user interface to cause an electronic mail invitation to be sent to an administrator representing a second party to the transaction, (b) limiting permissions of the administrator with respect to interaction that will occur between the first party and the second party in connection with the transaction, and (c) enabling the administrator to invoke an element of a user interface to invite additional individuals to form a team representing the second party in connection with the transaction.

In general, in another aspect, the invention features a method that includes (a) enabling a user to identify a stored template as an initial draft of the text of a contract for use in connection with a possible transaction, (b) enabling two parties to modify the text of the contract as part of a negotiation with respect to the transaction, and (c) enabling the two parties to assent to a final version of the text of the contract as governing the transaction.

Implementations of the invention may include one or more of the following features: The template may be an empty contract or a copy of an existing contract from another transaction that has been stored as a template. The contract may include a full-text prose document organized in sections. Each of the parties may have displayed to it any selected modification of the contract. Attributes may be embedded in the text of the agreement and each of the parties may define global values for the attributes.

In general, in another aspect, the invention features (a) maintaining a draft text of a contract that represents a current state of a negotiation between two parties with respect to a transaction, and (b) maintaining a control mechanism that gives only one of the parties at a time a right to edit the draft text.

Implementations of the invention may include one or more of the following features. The control mechanism includes enabling a party that has the right to edit to relinquish the right to the other party. Both parties may view the status of the edit right. At least one of the parties includes a team of individuals, and the control mechanism gives only one of the individuals at a time the right to edit. An individual who has the right to edit can relinquish it to another individual on his team or to the other party. Both of the parties comprise teams of individuals, and an individual who has the right to edit can relinquish the right to any other individual on either of the teams.

In general, in another aspect, the invention features a method that includes (a) enabling a party to a possible transaction to form a team of individuals to participate in electronically negotiating terms of a contract with another party to the transaction, (b) identifying one of the individuals as an administrator of the team, and (c) enabling the administrator of the team to control the electronic participation of other individuals on the team in the negotiating.

Implementations of the invention may include one or more of the following features. The controlling of the electronic participation includes controlling the rights of the other individuals to view, edit, or approve the terms of the contract, and controlling the rights of the other individuals to contribute electronic messages to the negotiation. Information about the team is stored electronically for later use in connection with another transaction. The administrator controls the membership of the team.

In general, in another aspect, the invention features a method that includes sending automatic electronic mail messages to parties engaged in an electronic negotiation of an agreement in connection with a transaction, the electronic mail messages providing notifications of state changes associated with the negotiation.

Implementations of the invention may include one or more of the following features: The state changes include changes to the agreement made since the electronic mail recipient's last viewing of the agreement. The state changes include the existence of newly posted messages with respect to the negotiation. An individual associated with one of the parties may control the volume of the electronic messages sent to him, e.g., based on the type of state changes represented by the messages. The type includes changes in the composition of a team associated with one of the parties, changes in the text of the agreement, the posting of messages, or changes in an approval status of the agreement.

In general, in another aspect, the invention features an Internet website that includes (a) a database containing documents pertaining to possible transactions offered by customers of the website, (b) an interface that permits separate websites to access descriptions of the possible transactions and to direct interested users to the Internet website, and (c) a negotiation interface configured to allow the users to negotiation online to reach the terms of a transaction with the customers that offered the transactions.

### DESCRIPTION OF DRAWINGS

FIG. 1 is a schematic block diagram of a system according to one embodiment of the invention.

FIGS. 2 is a map of a website.

FIGS. 3 and 3A show homepages included in the website of FIGS. 2.

FIGS. 4-10 are schematic concept diagrams of portions of the website of FIG. 2.

FIGS. 6, 6A and 6B are three thirds of one drawing, as are FIGS. 4 and 4A.

FIGS. 11-11B show windows accessible from a seller page of the website of FIG. 2.

FIGS. 12-12B show windows accessible from a buyer page of the website of FIG. 2.

FIGS. 13-21 show windows of an interactive user interface.

### DETAILED DESCRIPTION

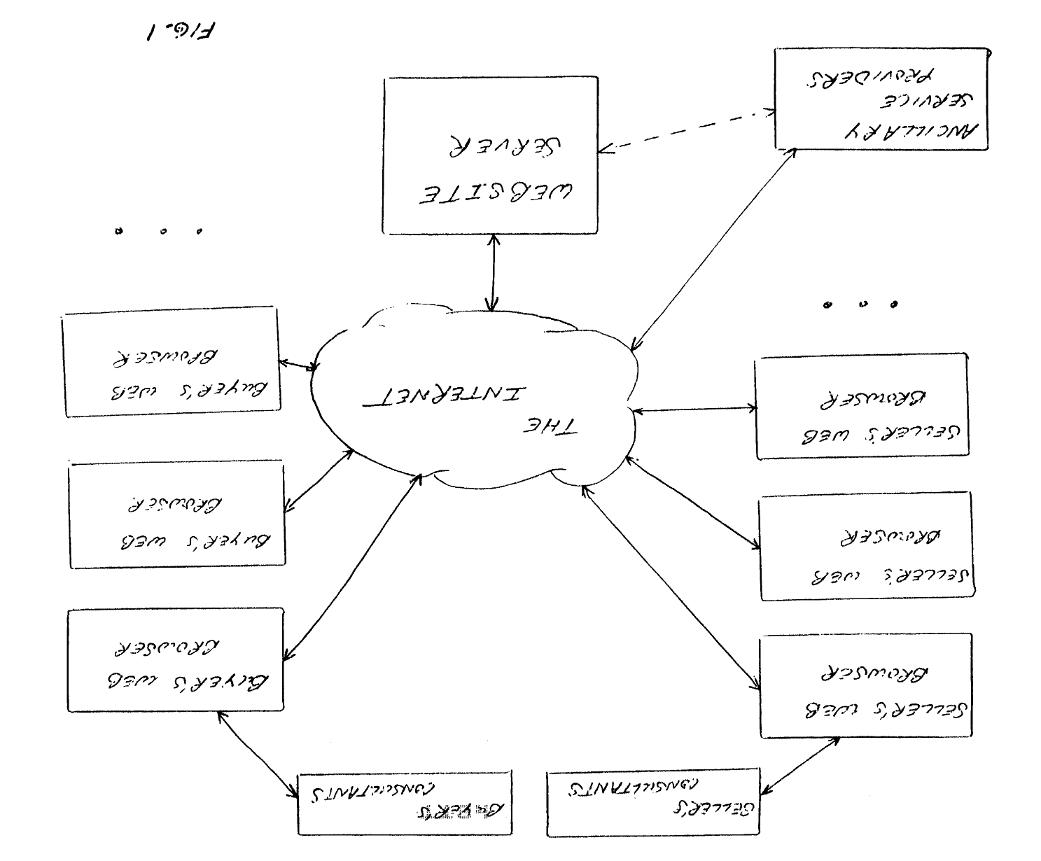

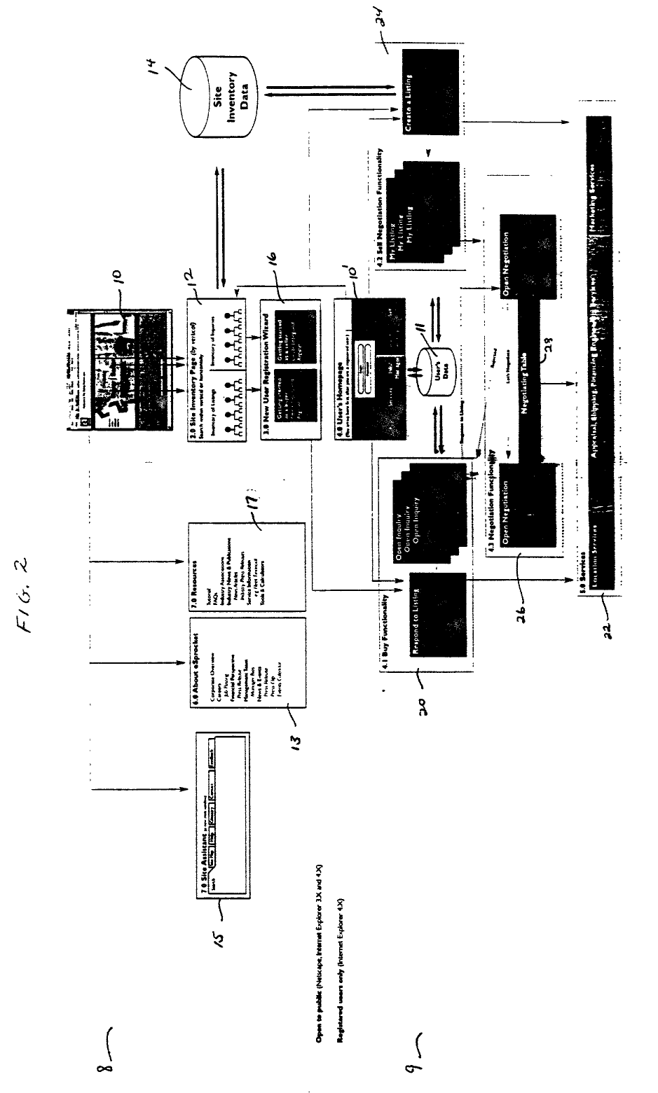

FIG. 1 shows a system by which buyers and sellers of capital equipment can negotiate the purchase and sale of such equipment over the Internet. Using a standard web browser, e.g., Internet Explorer, buyers and sellers can connect to a website (operated by a website server) via the Internet. The website server has application software programmed to implement the negotiating functions that will be described below. If services that are ancillary to the purchase and sale become necessary in order to implement the transaction, these services (e.g., shipping, engineering, financing or legal services) can be accessed either through links provided on the website, or directly through the website. The buyer and seller can also contact consultants of their own (for example, their legal counsel) directly, either online or using conventional means such as mail or fax.

There are a variety of ways in which the website host can derive income from hosting the website. The host can provide product marketing services to the website users, such as advertising and direct mail program support, and charge a fee for such services. In addition, or instead, the website host can collect a commission from the buyer and/or seller equal to a percentage of the purchase price.

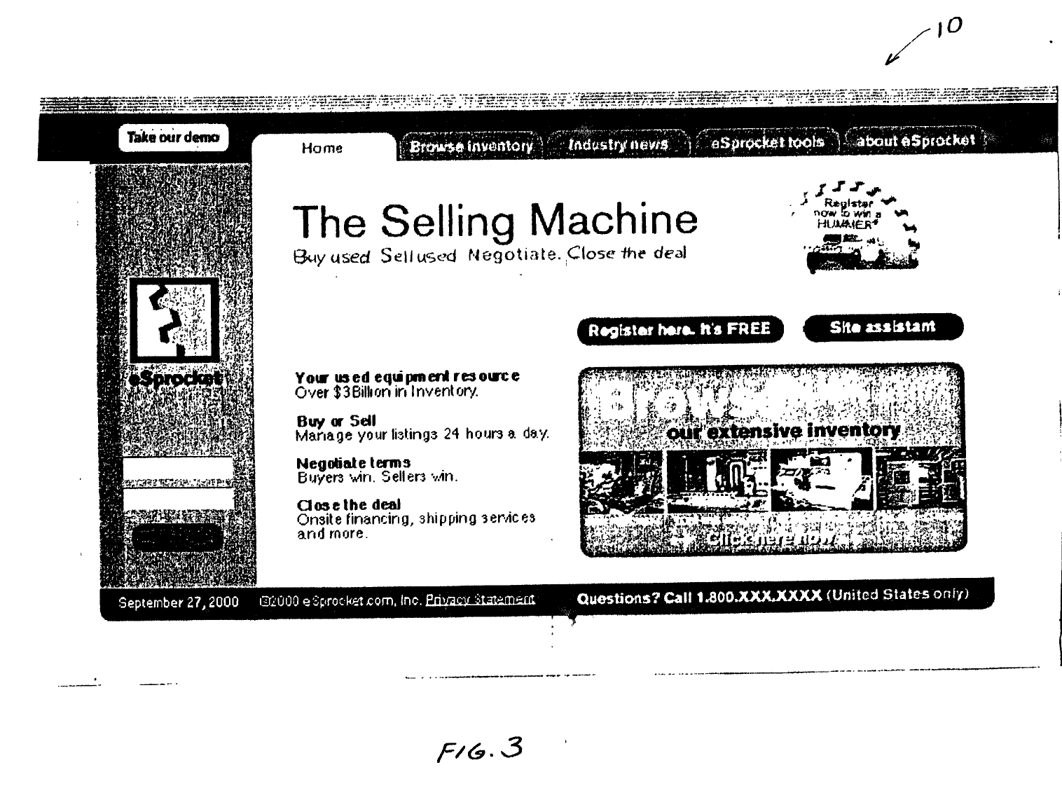

Referring to FIG. 2, the website includes a group 8 of publicly accessible pages, which can be accessed by anyone, and a group 9 of restricted pages, which can be accessed only by registered users. This arrangement prevents visitors to the website from viewing the details of an item listed for sale, entering into transactions, or entering information into the website's databases (discussed below) without first registering and providing information to the website server.

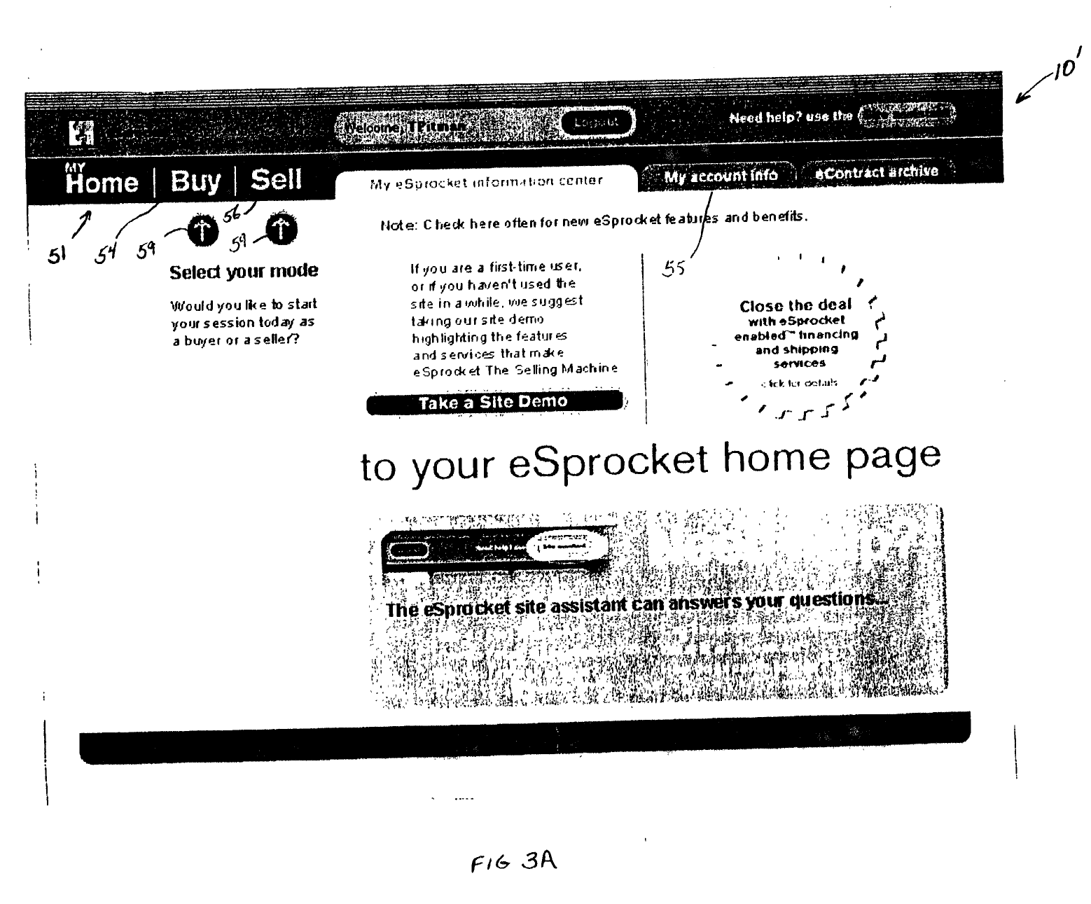

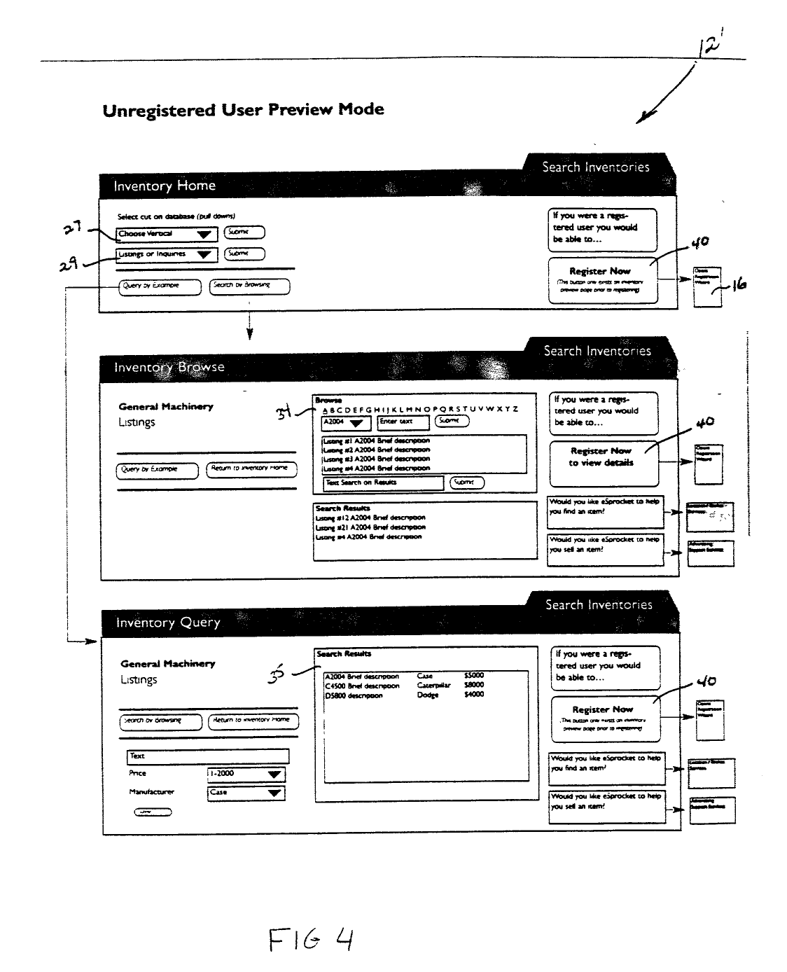

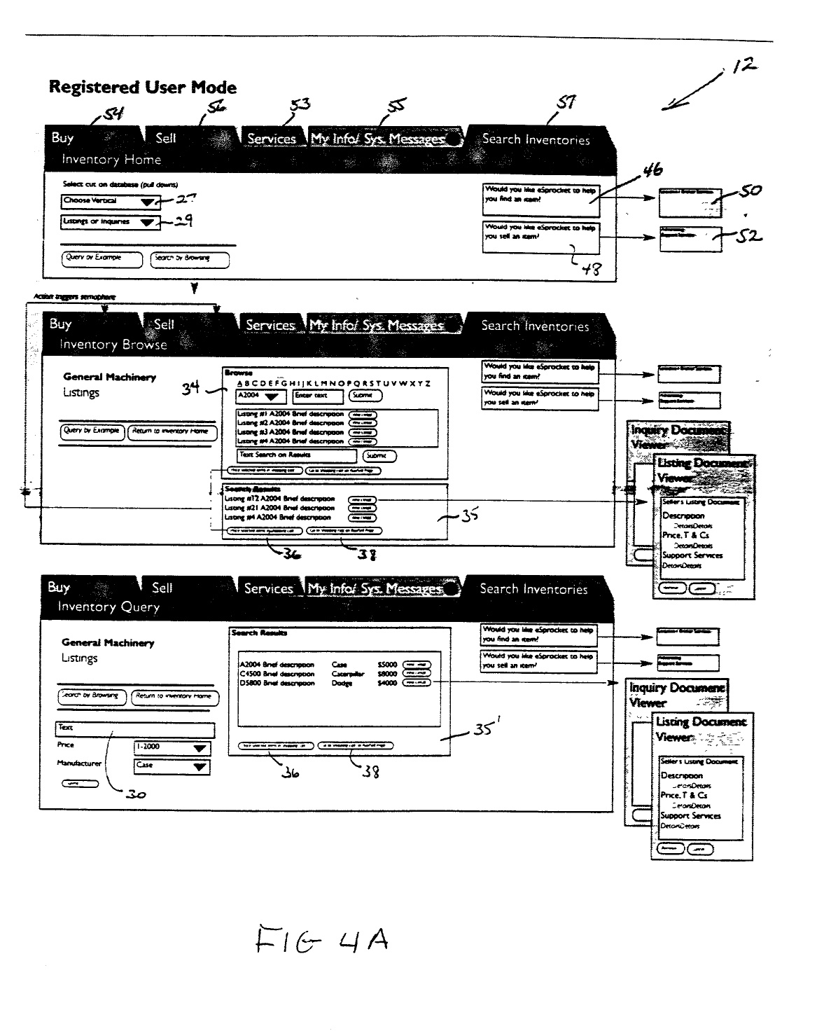

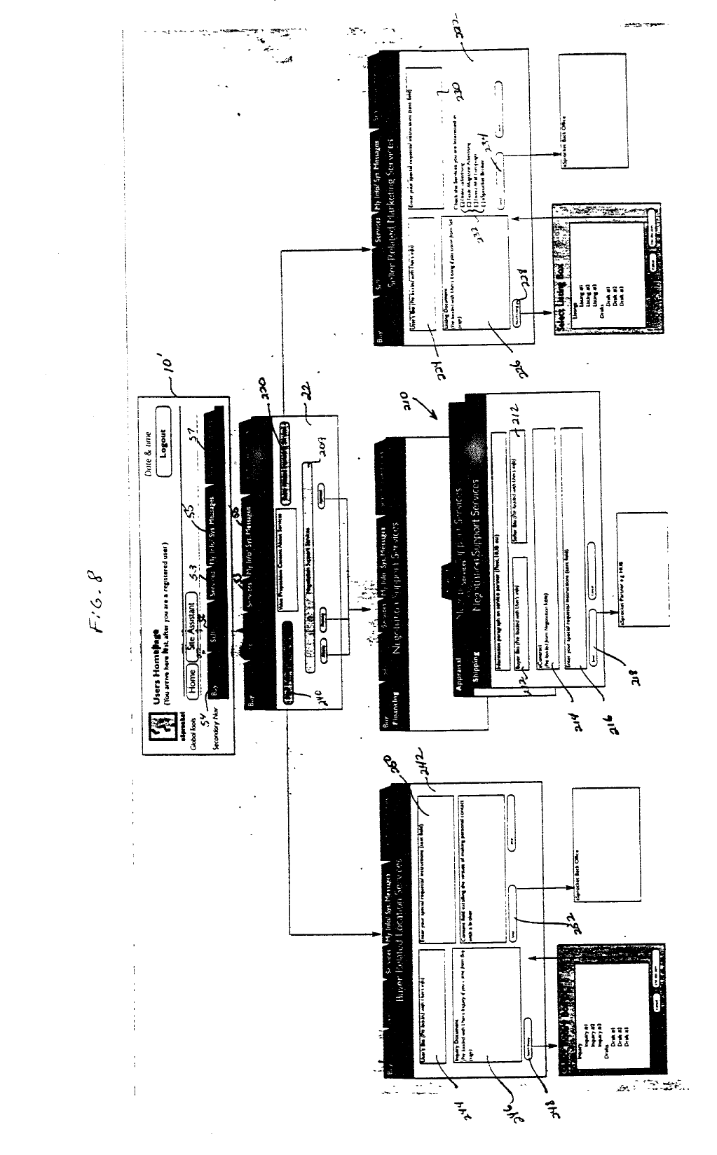

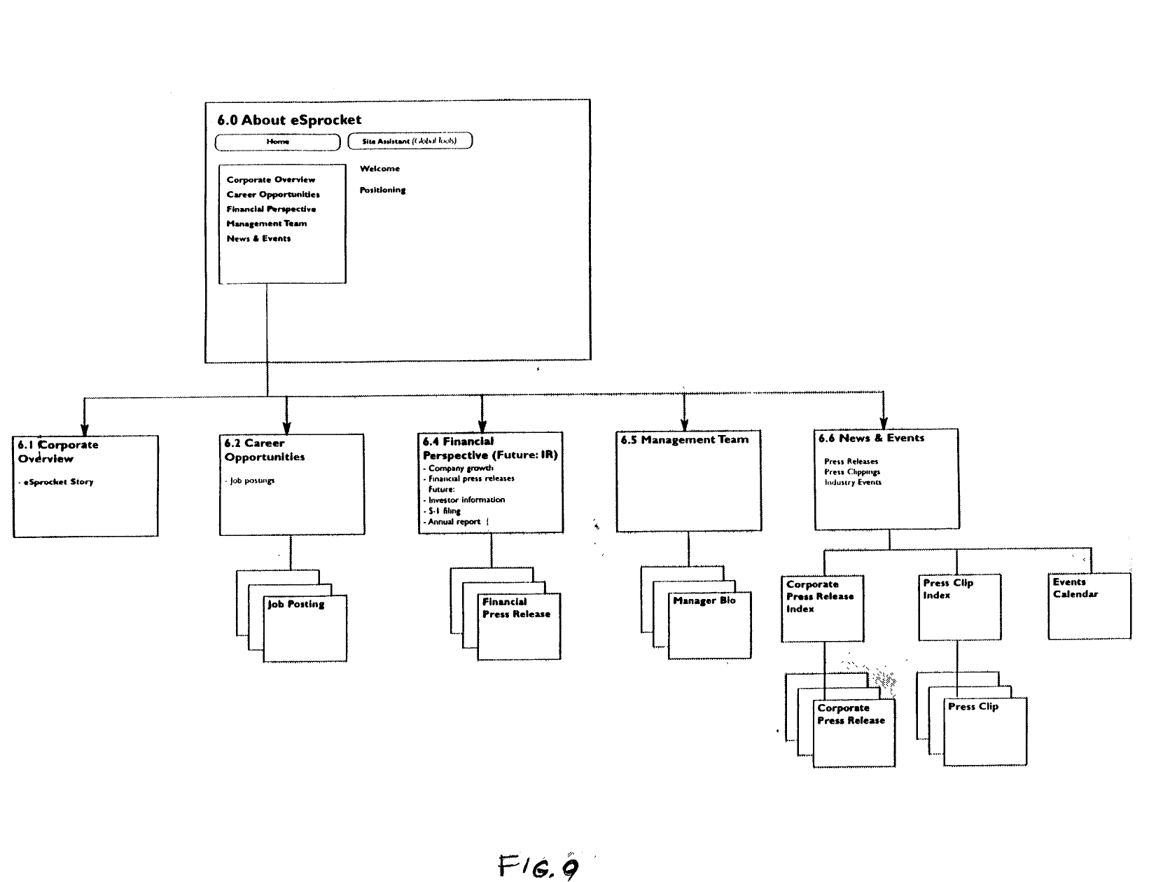

The website includes a homepage 10 that is viewed by a new or unregistered user when the user visits the website. A sample homepage is shown in detail in FIG. 3. From the home page 10, the user can navigate to a site inventory page 12, at which the user can search for items for sale and/or inquiries (requests for the purchase of items). Sample site inventory pages are shown in detail in FIGS. 4 and 4A, and will be discussed further below. The data that is accessed through the site inventory page 12 is stored in a site inventory database 14, maintained by the website server. Only registered users of the website can add data to the site inventory database. From the homepage 10, the user can also access an information page 13, to obtain information about the website host (a sample information page is shown in FIG. 9), a site assistant page 15, to obtain help in using the website, and a resources page 17, to obtain various general information and tutorials (a sample resources page is shown in FIG. 10).

New users who enter homepage 10 can also navigate to a new user registration page 16, shown in FIG. 5. The registration page can be accessed from the homepage by clicking on “new users start here” (FIG. 3), or from the site inventory page 12 by clicking on “register now” (FIG. 4). Using this registration page, the user can become a registered user, and thus obtain access to the restricted pages (group 9) discussed above. The registration wizard asks whether the user is a buyer, seller, or both; requests contact information and association affiliations; asks the user to choose a password and ID; and asks the user to fill in credit information if desired. If desired by the website host, a registration Wizard may be used rather than a registration page. Once the user has registered, the user will subsequently enter a registered user's personalized homepage 10′ (see FIG. 3A) upon visiting the website and entering his or her password and ID.

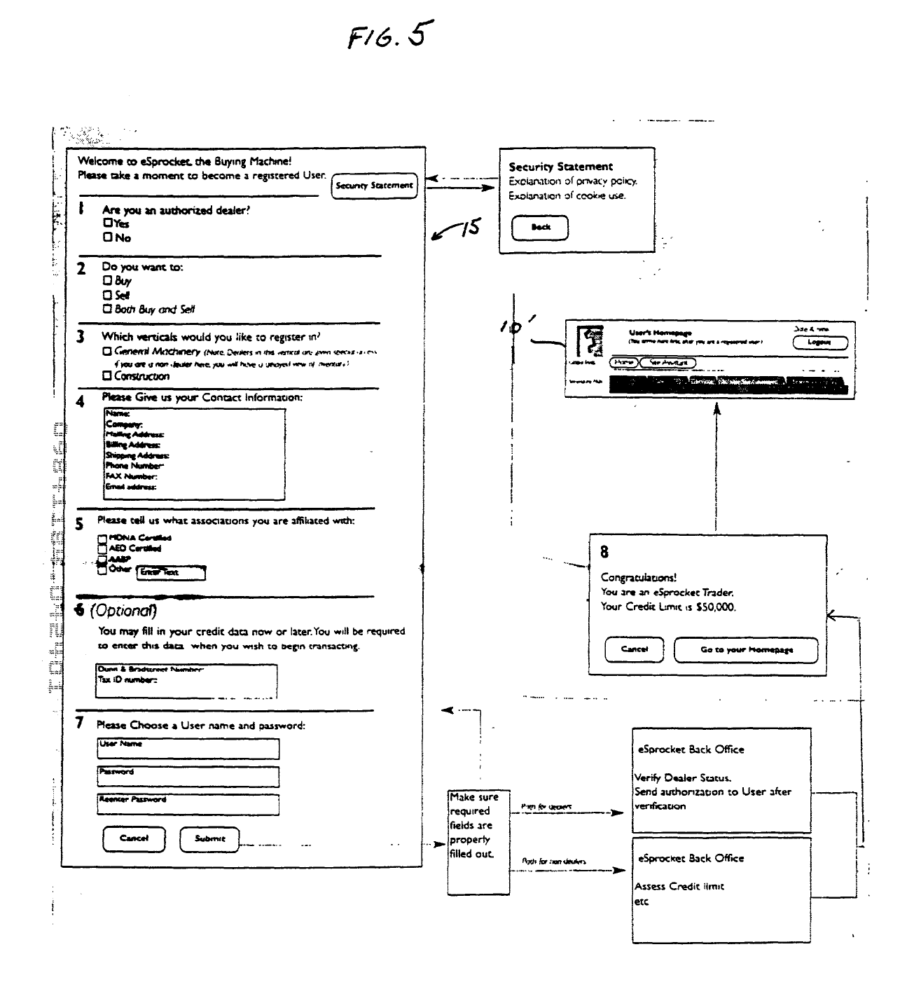

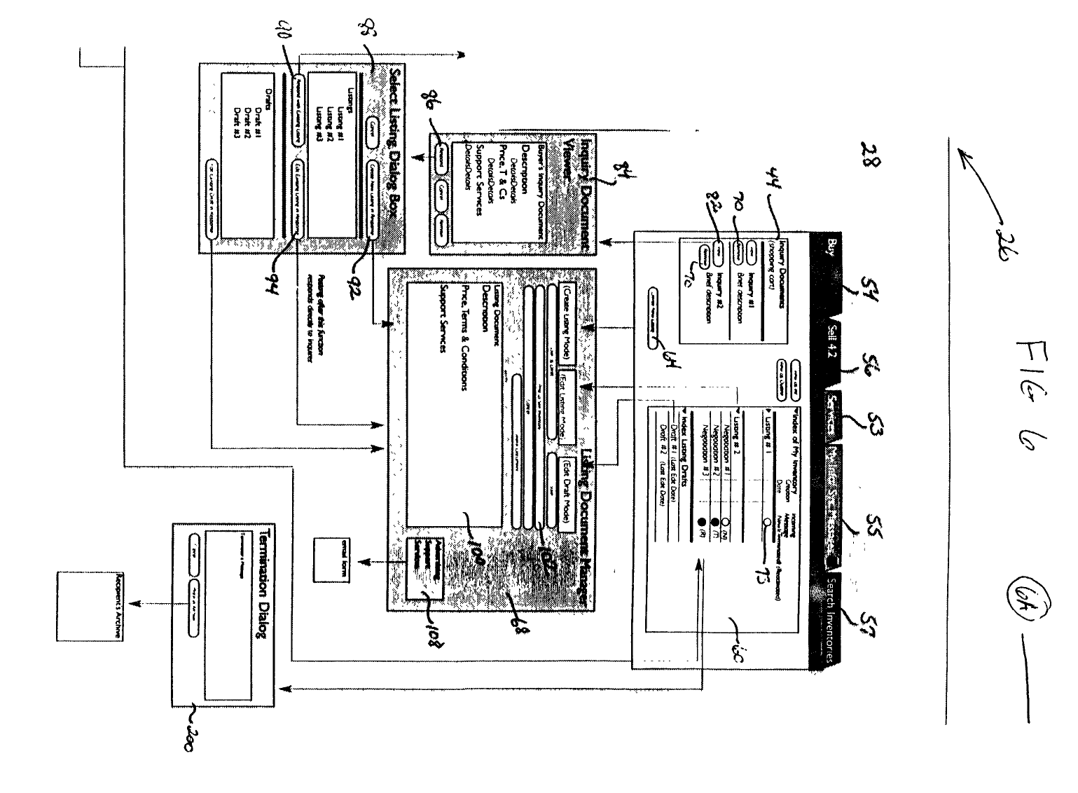

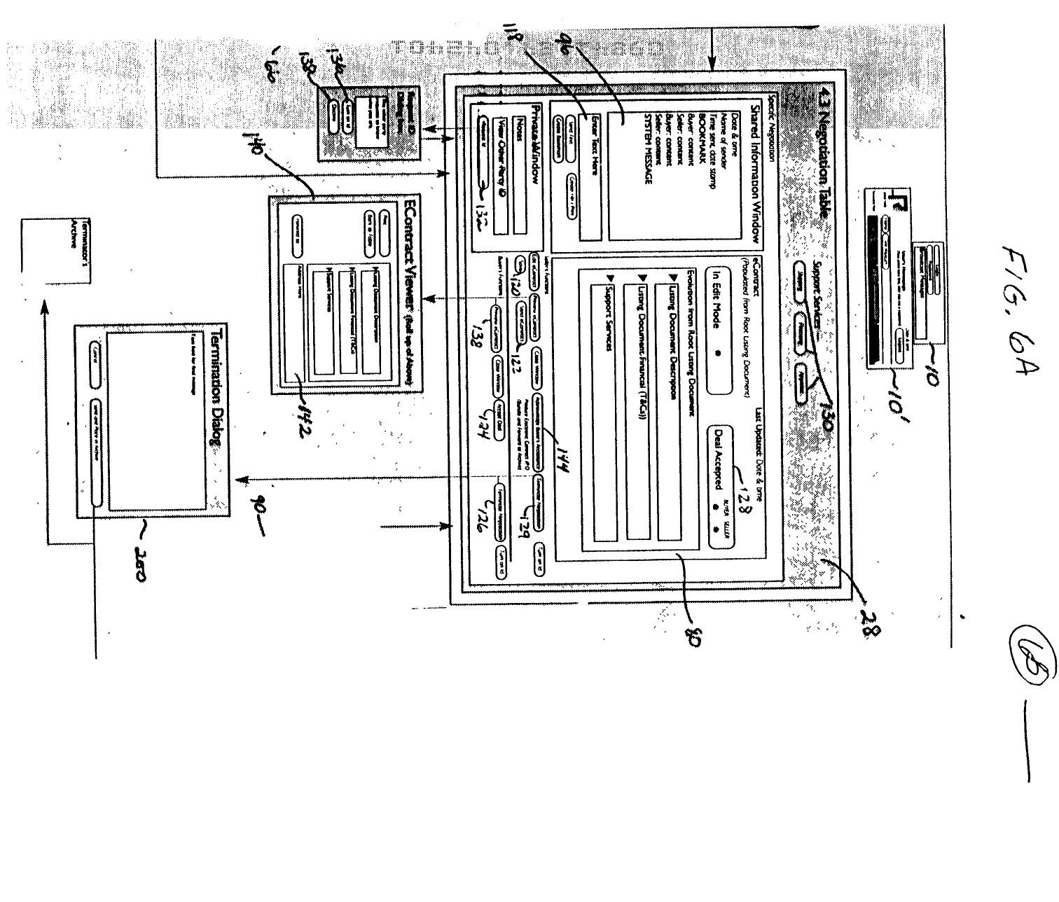

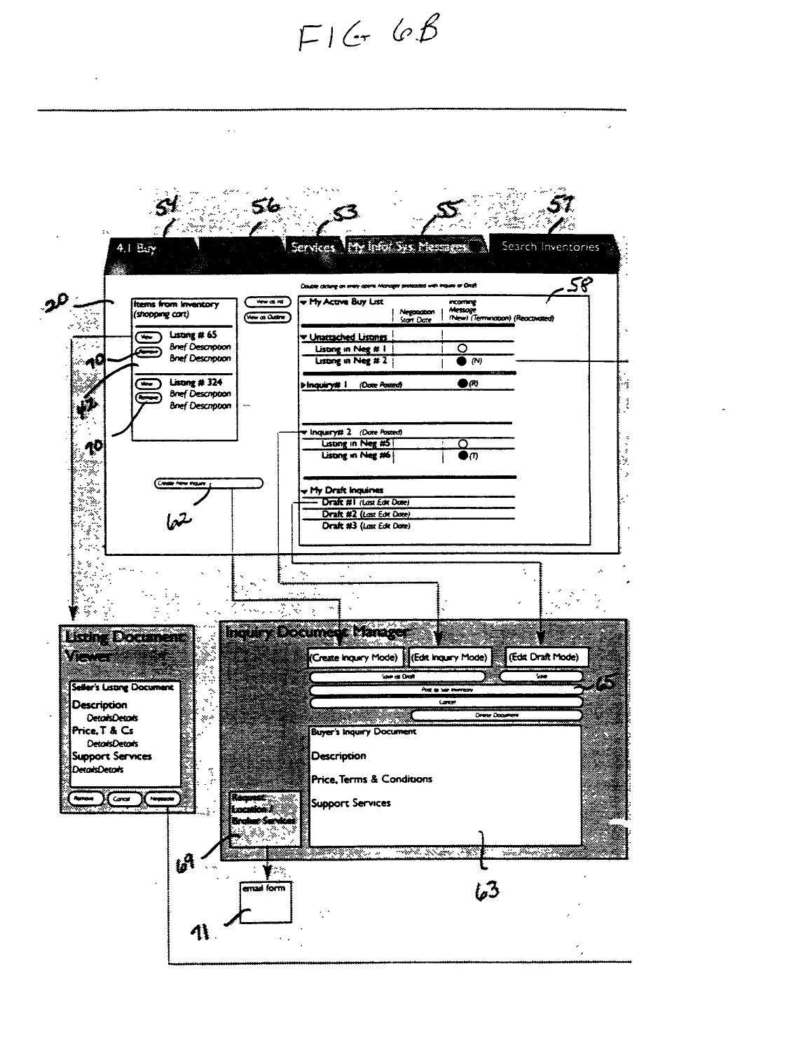

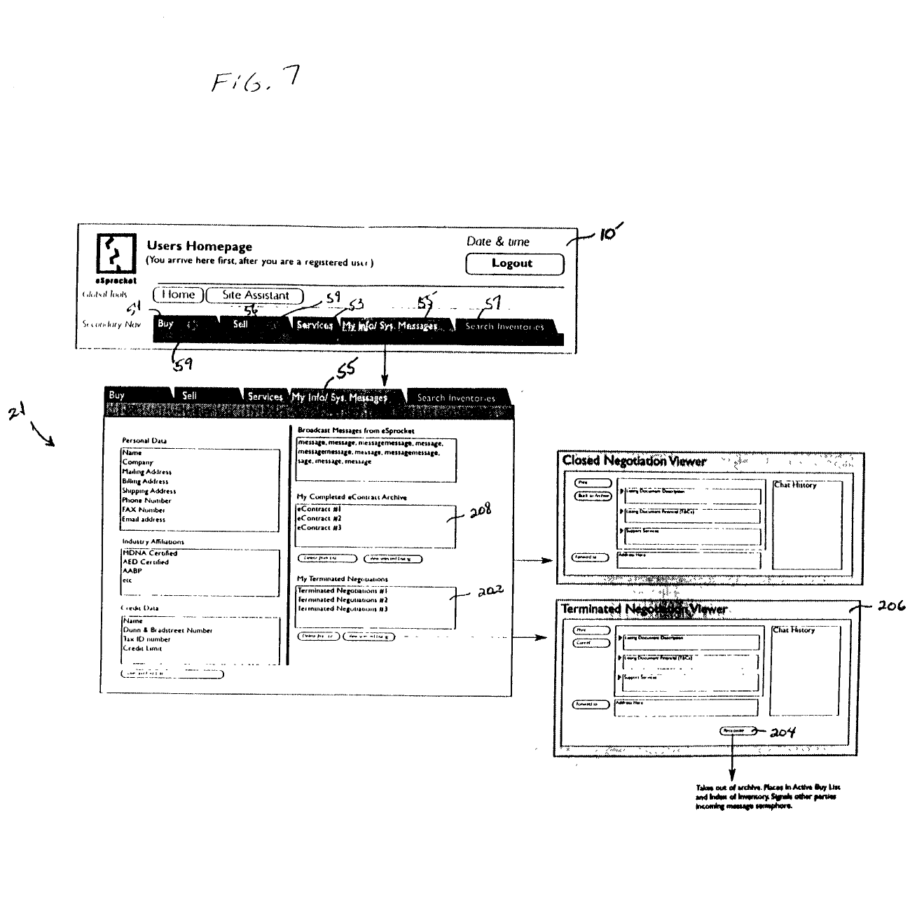

The registered user's homepage 10′ is personalized for the particular user, and contains information pertaining to that user's business (entered during registration), a list of the user's listings and/or inquiries, and the user's negotiations in progress. This information is accessible only to that user, and is stored in the user's database 11. Each registered user's homepage 10′ includes three navigation buttons: a buy button 54, a sell button 56, and a “my home” button 51 which allows the user to return to the site homepage 10, e.g., to access tutorials or general information and resources. The user's homepage may also contain a navigation tab 53, or a link (not shown), which allows the user to access a services page 22, shown in FIGS. 8 and discussed in detail below, to allow the user to obtain services such as appraisal, shipping, financing and engineering services through the website. The buy and sell buttons open buyer and seller pages 20, 24, shown in FIGS. 6, 6A and 6B and discussed below. The user's homepage also includes a navigation tab 55 (labeled “My account info” or “My Info/Sys. Messages”) that allows the user to access an account information page 21 (shown in FIG. 7) that shows the information entered by the user during registration, displays any messages received from the web server, and allows the user to view any completed and/or terminated contracts that the user has archived. A search inventories tab 57 (FIG. 4) opens the site inventory page 12, allowing the user to search for a desired item or buyer inquiry.

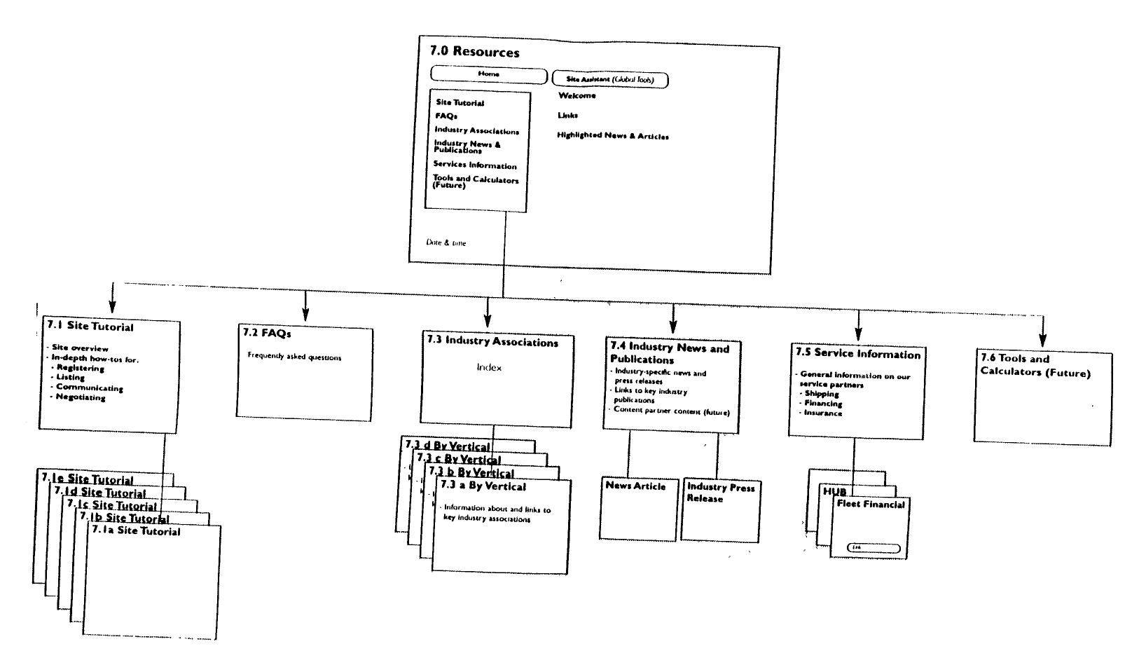

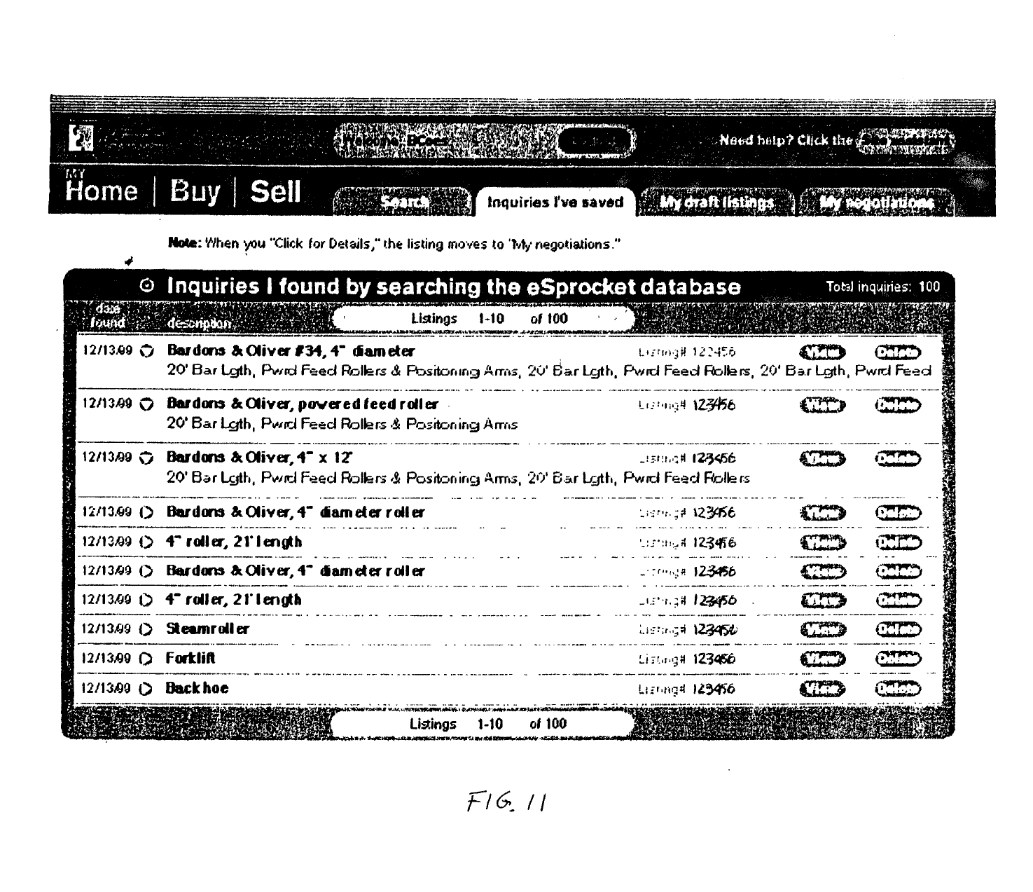

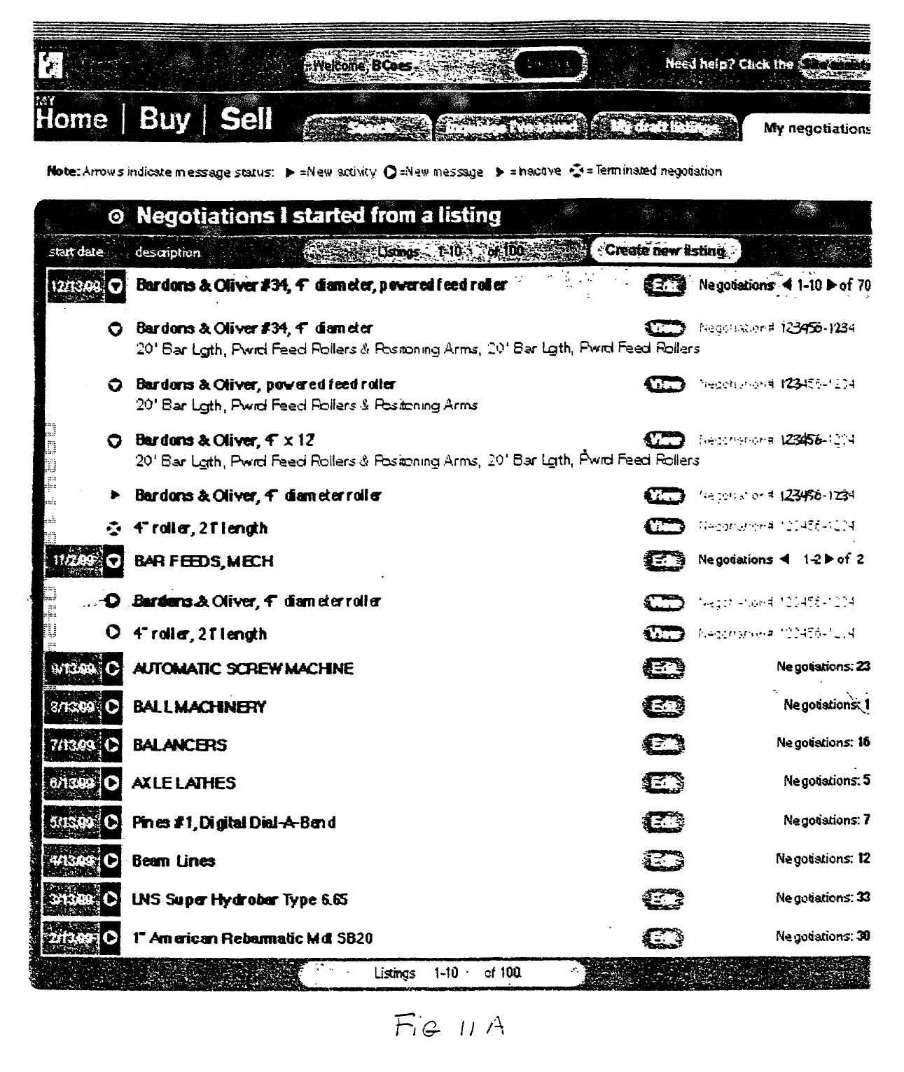

The buyer and seller pages 20, 24 allow the user to create an inquiry (describing an item that the buyer desires to purchase) or a listing (describing an item that is for sale). The buyer and seller pages also provide a negotiation functionality 26, which allows a buyer and seller to negotiate an agreement, e.g., for the purchase and sale of an item, using a virtual “negotiation table” 28. The negotiation functionality is configured to allow the parties to correspond online regarding terms of the agreement, and reach a final written contract as a result of this online interaction. At any time during negotiations, the buyer and/or seller can access the services page 22 and obtain assistance with regard to services needed to complete the transaction, as discussed below. The creation of inquiries and listings, and negotiation of an agreement, will be discussed in detail below. The buyer page displays a list 58 (“negotiations I started from a listing”), showing the status of ongoing negotiations for the purchase of items (if any), and the seller page displays an inventory index 60, showing the status of negotiations for each of the seller's listings. The buy list and inventory index will be discussed in detail below. Items can be deleted from the buy list and the inventory index by clicking on remove buttons (not shown). The buyer and seller pages also each include a semaphore 59 to indicate when new messages have been received. The buyer and seller pages are shown schematically in FIGS. 6, 6A and 6B; examples of windows that can be opened from a buyer and seller page according to one implementation of the invention are shown in FIGS. 11-11B and 12-12B.

Functions of the website will now be discussed in detail.

Creating Listings and Inquiries

Referring to FIGS. 6, 6A and 6B, a seller can create a listing describing an item for sale by clicking on the sell tab 56, entering the user's seller page 24, and clicking on the “create new listing” button 64 to enter the “listing document manager” window 68. This window provides a box 100 containing text fields into which the seller can enter information regarding the item for sale. If desired, the seller can create a listing by clicking an attach button and attaching an existing text document. Once the seller has entered information into box 100, the seller can save the information as a new listing, by clicking on button 102. This choice will add the new listing to the seller's inventory index list 60 (“my negotiations”, FIG. 11A), and will add the listing to the site inventory database. Once the listing has been saved, the seller can open the listing and edit it. If the seller wishes to send a listing directly to a particular buyer in response to an inquiry by the buyer, and thus spawn a negotiation table, the seller can do so by clicking on button 90, or by clicking on button 94, editing the listing, and posting the edited version. Window 100 also includes a request button 108, which the seller can click on to send a request for advertising services, e.g., if the seller wishes assistance in advertising or marketing items for sale. This service may be provided for a fee by the website host, if the host so desires.

A buyer can create an inquiry by clicking on the buy tab 54, entering the user's buyer page 20, and clicking on the inquiry creator button 62 to enter an “inquiry document manager” window 66. This window provides a box 63 containing text fields into which the buyer can enter information regarding the item that the buyer wishes to purchase. Once the buyer has entered information into the box 63, the buyer can save the information as a new inquiry, by clicking on button 65. This choice will add the new inquiry to the buyer's “active buy list” 58 (“listings I've saved”, FIG. 12), and will add the information to the site inventory database. Once the inquiry has been saved, the buyer can open the inquiry and edit it. Window 66 also includes a request button 69, which the buyer can click on to send a request for location/broker services, e.g., if the buyer wishes assistance in obtaining a particular item. The website host may provide these services or a link to providers of such services, or clicking on this box may bring up a window 71 prompting the buyer to send an email request to an outside provider.

The buyer can also access location services by clicking on the “buyer related location services” button 240 on services page 22 (see FIGS. 8). Doing so will open a window 242 that includes information on the user (box 244, preloaded from the user's information obtained during registration), a copy of the user's inquiry document (box 246, either preloaded, if the user entered from his or her seller's page, or attached by clicking on box 248), and any special requests or instructions typed in by the user (box 250). The user can then send the request online, by clicking the send button 252.

When a negotiation on the sale of a particular item is successfully completed, the seller is prompted with a notifier asking if they want the listing removed from the inventory database. If the seller chooses “yes,” the listing will be removed from the inventory and from “My Listings.” If the seller chooses “no,” the listing will remain in the inventory database.

Searching for Listings and Inquiries

Site inventory page 12 is shown in FIG. 4. This page allows registered buyers and sellers to search horizontally or vertically for a particular item, or for inquiries pertaining to a certain type of item. (Unregistered users will view a “preview mode” site inventory page 12′, shown in FIG. 4A, that is similar to site inventory page 12 but does not allow the user to perform certain functions.)

The user can select between horizontal or vertical searching using drop down menu 27, and between listings and inquiries using drop down menu 29. The user can enter a text search into text box 30, or can enter a query by example, e.g., by item description, manufacturer or location, using drop down menus (not shown). The user can also browse for a desired item or inquiry using the “inventory browse” window 34. For example, if the user owns a construction company and is looking for a one-operator backhoe, he would browse using the terms, “Construction Equipment”→“Backhoe”→“One person.”

Search results are displayed in boxes 35 and 35′. Advertisements for items that are relevant to the user's search request are displayed in a “hot list” box (not shown). Registered users are given the opportunity to put items or inquiries that are displayed in boxes 35 or 35′ into a virtual item shopping cart 42 or inquiry shopping cart 44 (see FIGS. 6 and 6A) by clicking on box 36. A registered user can view the contents of his or her shopping cart by clicking on box 38. Unregistered users cannot access a shopping cart, but are given the opportunity to register by clicking on box 40. Items can be deleted from the shopping carts by clicking on remove buttons 70.

The site inventory page 12 also gives users the opportunity to ask for help in locating or selling an item, by clicking on boxes 46 and 48, respectively. If a user clicks on box 46, the user is referred to a location/broker service 50. If a user clicks on box 48, the user is referred to an advertising support service 52. As discussed above, these services can be provided either by the website host, or by an outside provider. An outside provider may be contacted by sending an encrypted (secure) email message to the provider with the pertinent information about the item and the sale. In other implementations, the website server communicates directly with these providers' back end systems and provides automatic electronic quotes and procurement.

The seller can also access advertising support services by clicking on the “seller related marketing services” button 220 on services page 22 (see FIGS. 8). Doing so will open a window 222 that includes information on the user (box 224, preloaded from the user's information obtained during registration), a copy of the user's listing document (box 226, either preloaded, if the user entered from his or her seller's page, or attached by clicking on box 228), and any special requests or instructions typed in by the user (box 230). The user can also indicate what type of services the user is interested in receiving, by checking boxes 232. The user can then send the request online, by clicking the send button 234.

Opening a Negotiation

A negotiation regarding a particular listing can be initiated in one of two ways. A buyer can initiate a negotiation by clicking on a negotiate button in the listing document viewer (this page, not shown, is identical to the eContract portion of the negotiation table window 28, except that instead of the deal accepted buttons it includes a negotiate button 76 and a cancel button 78). Clicking on the negotiate button will give the user a choice of one or more agreement templates associated with the listing, prompt the user to create his team, issue invitations to team members, and automatically send an invitation to the seller of the item, activating the incoming message semaphore 73 that is associated with the listing in the seller's inventory index 60, and spawning a negotiation table 28 for the item. The negotiation table will initially be populated with a template document supplied by the seller and associated with the listing (this information goes into the eContract section 80 of the negotiation table 28). Clicking on the negotiate button also moves the item from the buyer's shopping cart 42 to the buyer's active buy list 58.

A negotiation can also be initiated by a seller responding to a buyer's inquiry with a specific listing. The seller does this by putting the inquiry in his or her shopping cart 44, and then clicking on the view button 82 in shopping cart 44 that corresponds to the particular inquiry. This brings up a display of the “inquiry document viewer” page 84 for the inquiry. By clicking on the respond button 86, the seller can then view a “select listing” dialog box 88 that lists all of the seller's listings and allows the seller to highlight the desired listing and click on one of three buttons to respond with a listing. The seller can choose to respond to the inquiry with an existing listing that was previously posted by the seller (by clicking on button 90), to generate a new listing in response to the inquiry (by clicking on button 92) or to edit an existing listing (by clicking on button 94). Posting a listing presents the seller with one or more agreement templates appropriate to that listing from which to choose, which then creates a negotiation from that template, presents the seller with the Build Team interface, which prompts the seller to issue invitations to their team, issues an invitation to the buyer, and spawns a negotiation table.

Creating a Team and Issuing Invitations

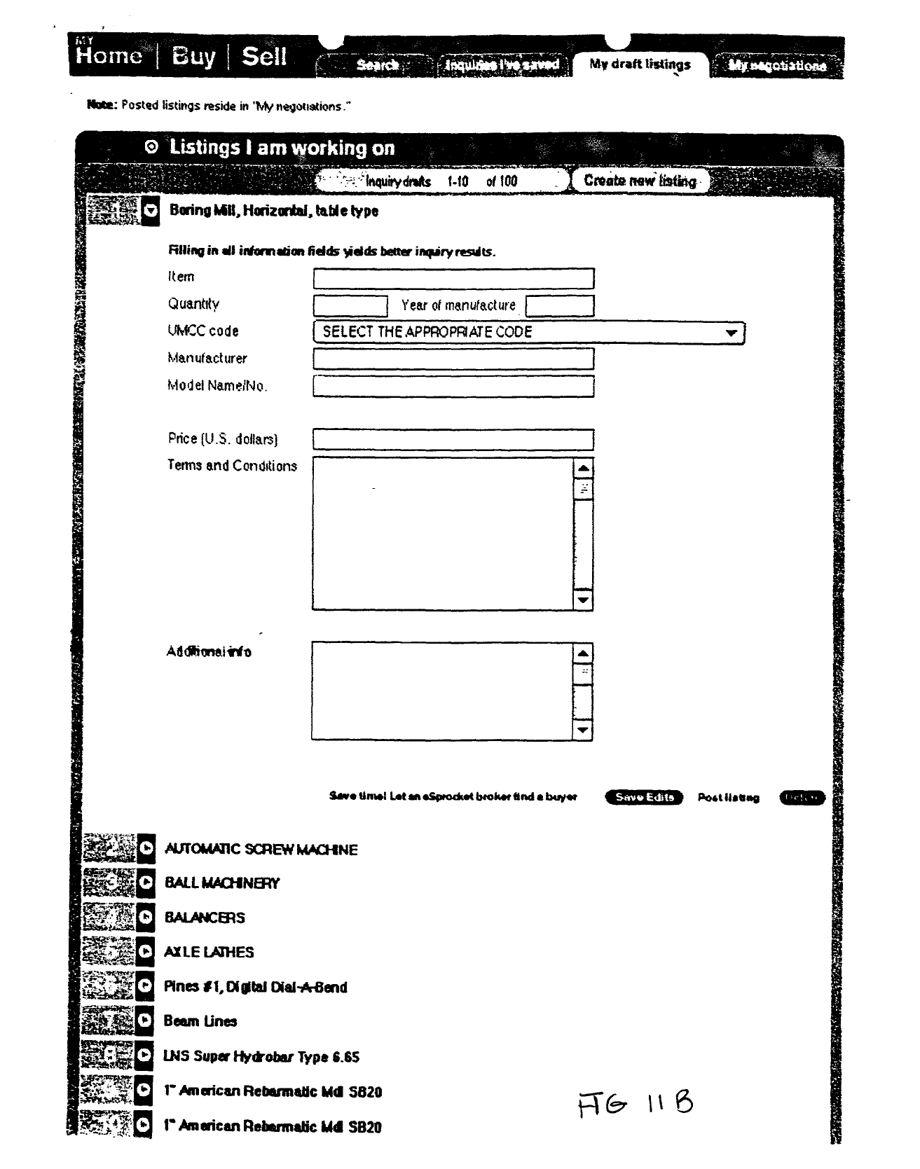

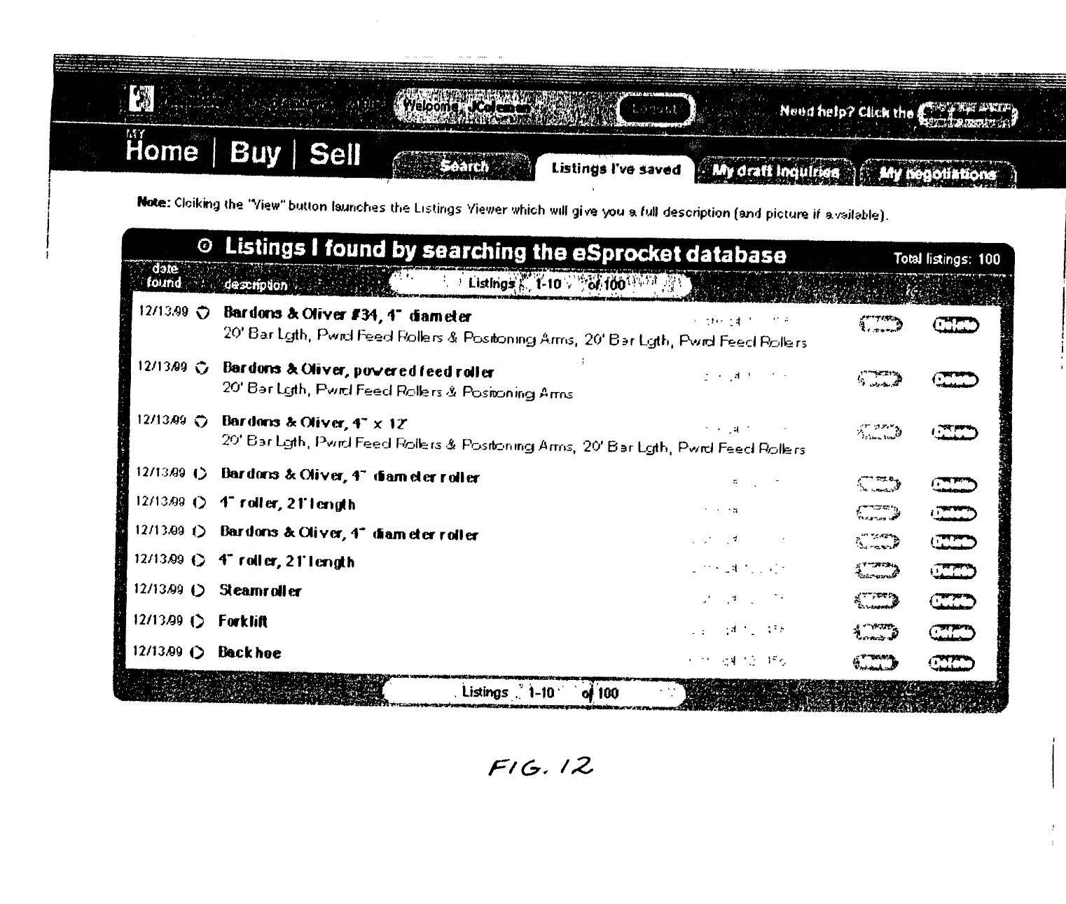

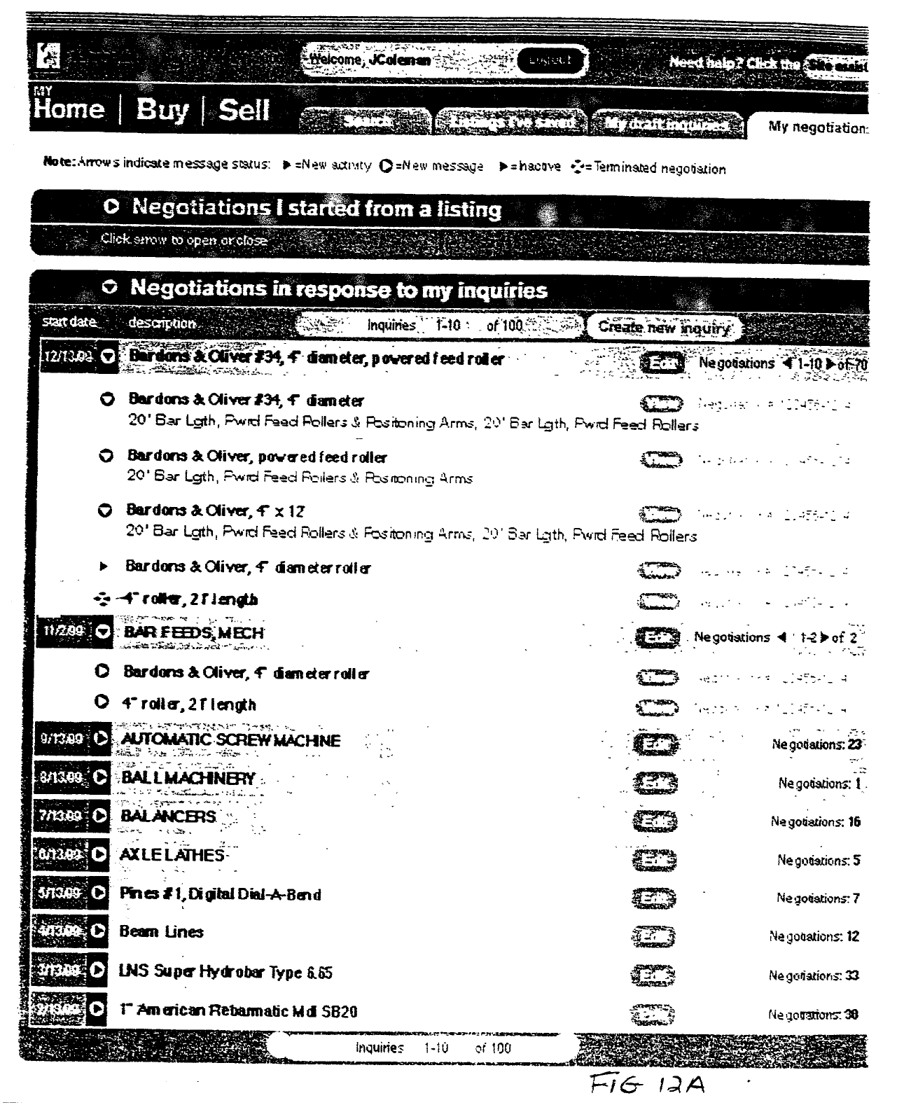

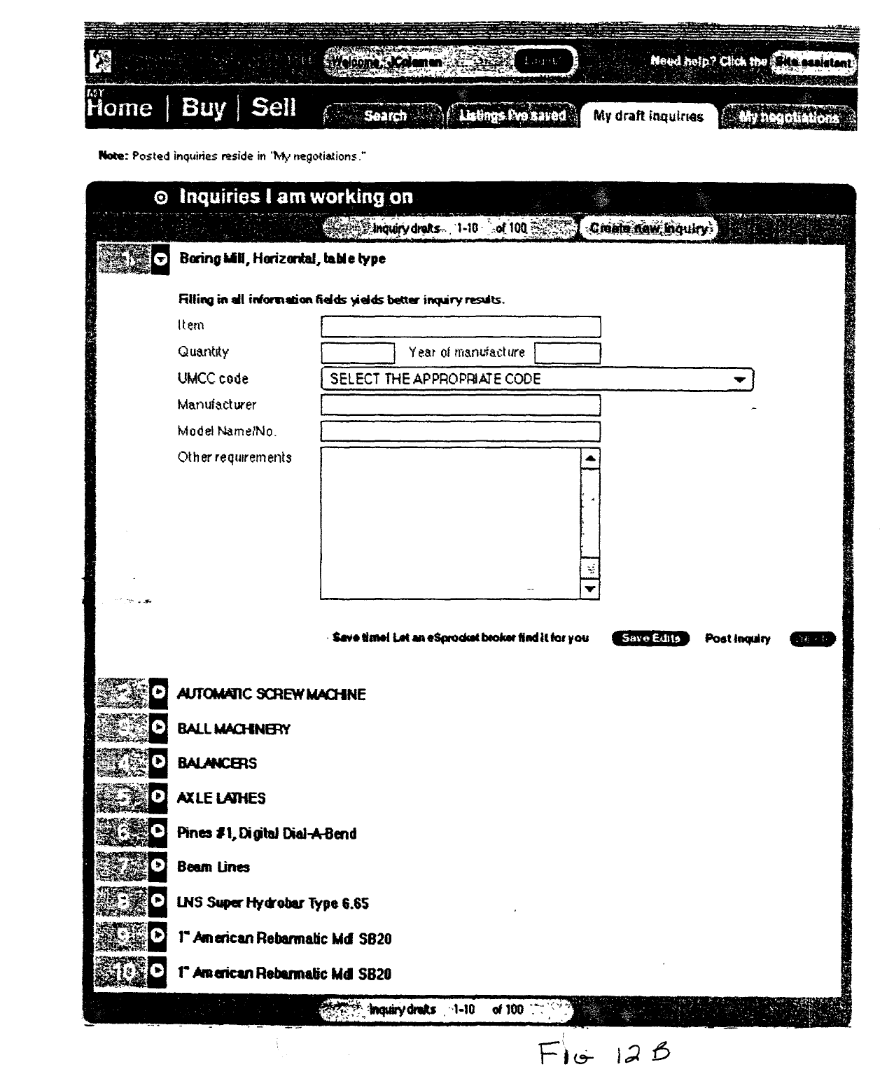

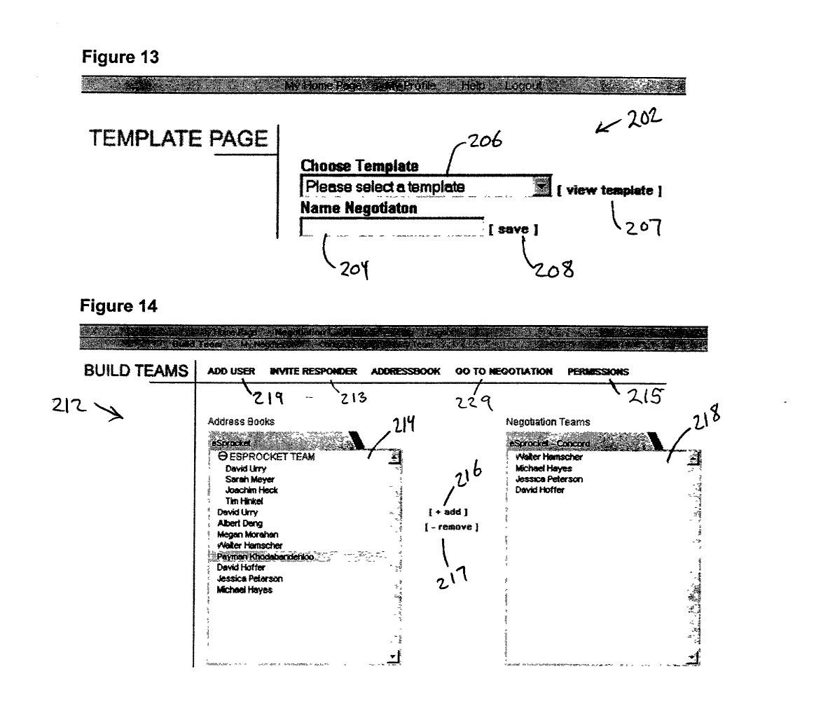

Once the negotiation table has been spawned, the Template Page 202 (shown in FIG. 13) prompts the user to give the negotiation a name 204 and to select a pre-stored document template 206 that will serve as a starting point for the negotiation. By clicking on the View Template command 207, the user may see the actual template that is currently selected in box 206. Once the user locates the desired template, he clicks the save command 208, which creates the negotiation record on the server and advances him to the Build Teams page 212 shown in FIGS. 14 through 16.

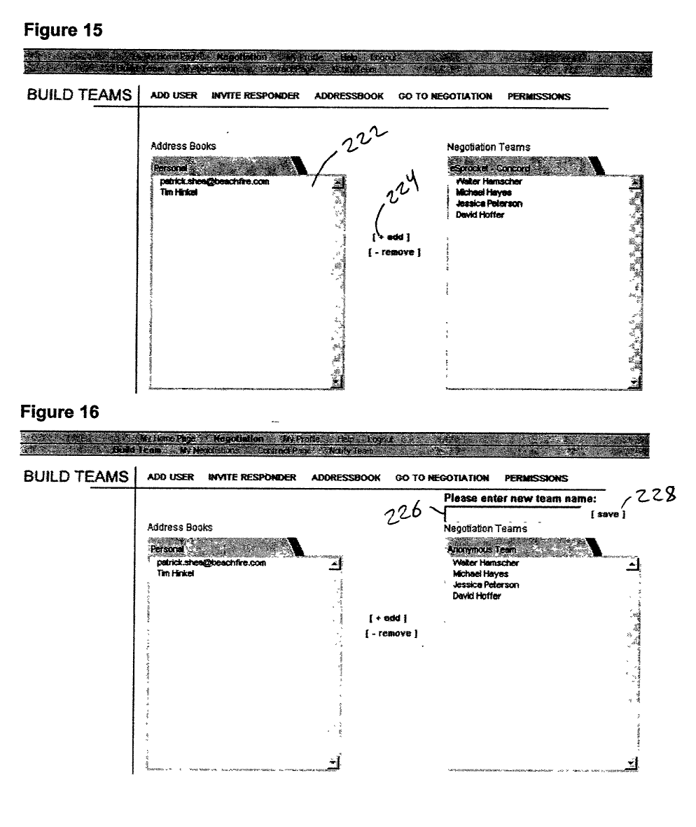

In the Build Teams page 212, the user can either choose one or more teams (that have already been configured) or individuals from an Enterprise wide address book in list box 214 and click the Add command 216. The list box 214 enables a user to scroll to find the names of users to be included in the new team. When an address is highlighted, the user adds it to the list by clicking on the Add command 216. The current team being built is shown in list box 218. Any individual can be removed from the team by clicking the Remove command 217. Users can also choose to select team members from a personal address book 222 as shown in FIG. 15, also by clicking the Add command 224. Other email addresses not included in the Enterprise address book 220 or the Personal address book 222 can be added by clicking the Add User command 219, which prompts the user for an e-mail address and an invitation message. Teams can be saved to the personal address book or to the Enterprise address book, according to the privileges of the current user, by entering a new team name 226 and clicking the Save command 228 (in FIG. 16).

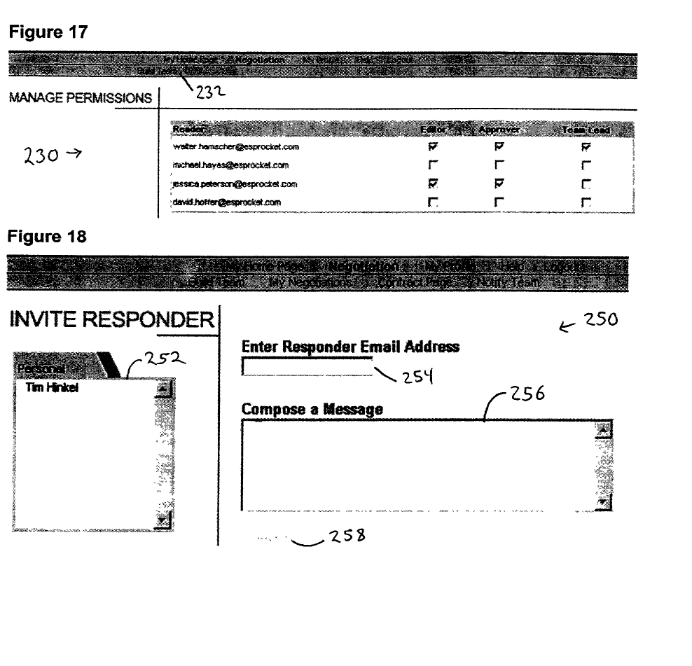

Clicking the Permissions command 215 sets permissions associated with each member of the new team. The Manage Permissions page 230 is shown in FIG. 17. The privileges can include, at least, the ability to edit the document, approve the contract, or add and remove users and set their permissions as the Team Lead of the negotiation. Check boxes indicate for each combination of user and privilege whether that user has that privilege. When the user has changed the permissions on this page, the changes are saved permanently when they leave the page, for example by returning to the Build Team page by clicking the Build Team command 232.

By clicking on the Invite Responder command 213 of FIG. 14, the user is presented with the Invite Responder page 250 shown in FIG. 18. On this page, the user is presented with an address book 252 listing email addresses of people from the “other side” who may be invited to participate in the negotiation (in the example shown, only one person is listed in the box). Additions can be made to the list in the box by typing within box 254, adding an invitation message in box 256, and clicking the Send command 258. Clicking the send command returns the user to the Build Teams page. At any point in building the teams, the user can go to the agreement interface by clicking the Go To Negotiation command 229.

Once the negotiation has been created, the initiator may issue an invitation to the responder using the Invite Responder command 213. The responder from the other side is presented with an invitation to participate in a negotiation with the indicated team members based on the chosen agreement template. The responder becomes the administrator of the other team and then uses a similar process and interface to identify his team members and their permissions.

The administrator of the responding team may not grant privileges to any user that had not been granted to him by the initiating user in the first place. The initiating user may, for example, choose to limit the edit privileges only to his own team.

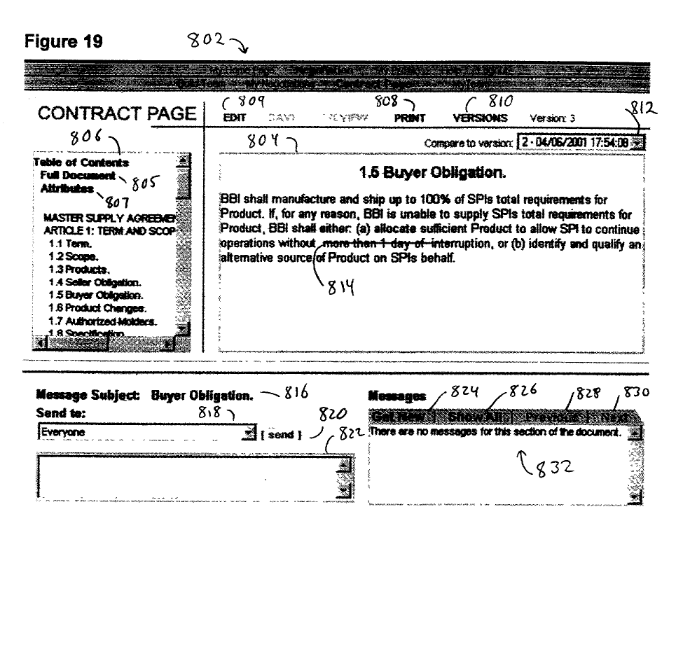

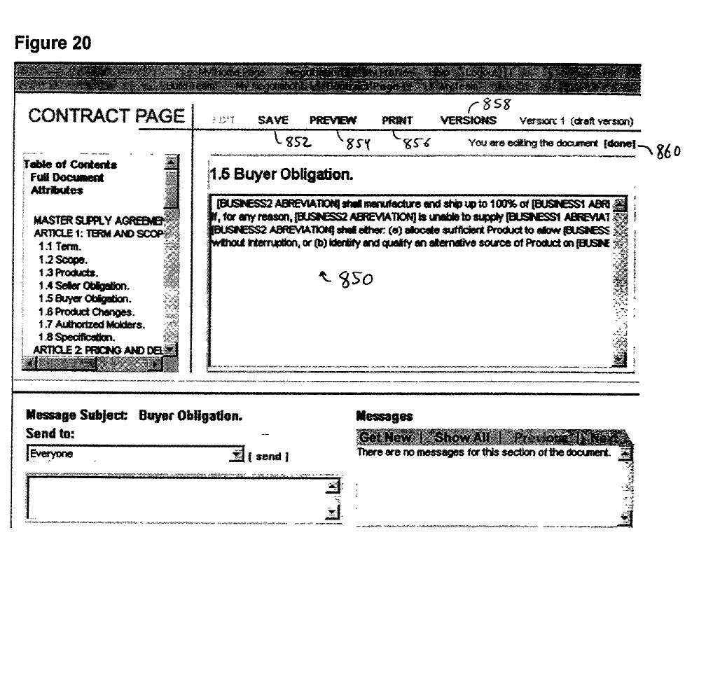

Any user on either team can view the team members of both teams and their privileges at any time using the page of FIGS. 19 and 20. A user with the Team Lead privilege can add and remove users and change permissions at any time.

Negotiating a Transaction

Once the negotiation has been created and the negotiation table has been spawned, the “eContract” window 80 is populated with the information from the chosen document template associated with the seller's listing. The seller can then choose to wait for a response from the buyer to this initial agreement, to edit the agreement (if he has permission to do so), or to correspond with the buyer. To send a message to the buyer, the seller enters text into the “enter text here” box 118 and clicks to send the message. The seller can also attach a file, e.g., a price list contained in a spreadsheet file. The file will then be accessible to the buyer through the negotiation table.

Another example of a contract window 802 is shown in FIG. 19. In window 802, a scrollable box 804 sets forth the text of the agreement, based on the template, in its current state. A side bar 806 contains an outline of the sections of the agreement as well as navigational links to allow the user to view the full document 805 or selected attributes 807. To edit the agreement, a user must obtain a “write lock”. If he does not have a current write lock, he can request it by clicking the “edit” button 809 . If another user currently has a write lock, the system indicates to the user via a pop-up dialog that editing is not then available. Users may choose to be automatically notified via e-mail of all changes in the status of the write lock. Once notified, the user may choose to return to the contract, request the write lock, and receive it if any other user has not taken it in the interim. Also, the current holder of the write lock is displayed in the agreement window, allowing the user to contact that user directly if he so desires. If the write lock is free and a user clicks the edit button 809 the user is then allowed to edit sections of the agreement.

The contract page 802 also includes commands to print 808, show previous versions 810, or compare the current version to previous versions 812 by showing highlighted (“redlined”) text 814 that differs from the selected previous version.

The contract page 802 also includes a message area where users can send each other text messages whose text content is typed into a scrollable box 822; whose subject is either the full document or the current section 816; which will be visible either to everyone (team members of both sides) or only to the user's own team 818; and which will be sent upon pressing the send command 820. Messages can be sent to the user's team or to everyone, using the send to box 836 and the message text box 822. A message can be applied to the whole document or only to a particular section of the document. A box 832 contains a list of messages that pertain to the current section of the document (none are shown in the example). The Get New button 820 will cause the message area 832 to display all messages sent since the last refresh, and the Show All button 822 will cause all messages to be visible in the scrolling box 832.

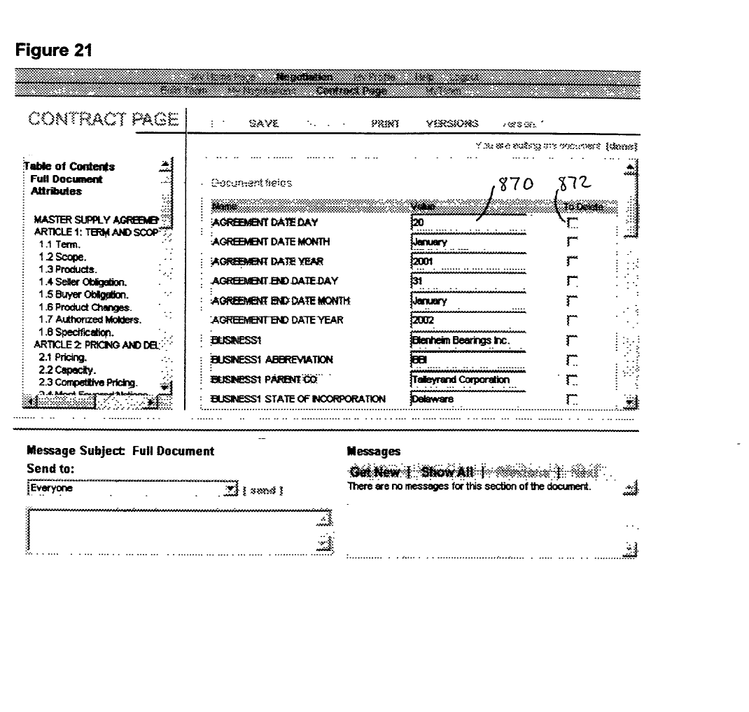

As shown in FIG. 20, once a user has the write lock, he may edit the contract text in a scrollable box 850, save 852 a draft, a version for his own team, or a public version visible to both teams. Until the contract is published, other users, including those on the other team, cannot view the revised contract. The user can also display a preview 854 of the agreement as it will be seen by other users, or print the current version using the print button 856, or yield the write lock by clicking the done command860 and indicating whether the write lock is to be yielded only to others in his team with edit privileges, or be yielded to members of either team having edit privileges. As shown in FIG. 21, the text editing box 850 allows the user to insert references to document “attributes”, also called “fields”. Attributes of a document are named text values into which users can place text 870 that will then be inserted in place of every reference to the corresponding attribute throughout the document whenever it is previewed 854 or printed 856. Attributes can also be deleted 872 or added (not shown). After the user publishes a revised contract, an authorized user on the other team can choose to either accept the published contract, by clicking on the “accept deal” button 124, terminate negotiations, by clicking on the “terminate negotiation” button 126, or propose changes to the contract by sending the seller a message in the message window 96. If the buyer chooses to accept the current version of the contract, the buyer semaphore in the “deal accepted” box 128 will be activated. If the buyer wishes to send the seller a message, the buyer can do so as described above, by entering text in box 118 and/or by attaching a file.

The seller, in turn, can respond by editing the contract and posting a revised contract (e.g., incorporating the terms suggested by the buyer or other terms acceptable to the seller), by sending a message to the buyer, or by terminating the negotiation by clicking on terminate box 129. While the seller is editing the contract, and until the seller posts a new version, the buyer can only view the last posted version of the contract.

The buyer and seller can continue to communicate in this manner until either an agreement is reached or one of the parties decides to terminate negotiations. Each time one party responds to the other (or the seller publishes a new version of the contract), a semaphore indicating the change occurring on that particular negotiation is activated on the other party's buy list or inventory index or list of active negotiations. These semaphores provide a visual indication that the status of the negotiation has changed. When the seller is editing the contract, the deal accepted box 128 is replaced temporarily by a “contract in edit” box (not shown).

Changes made by the seller to the contract will not affect the contents of the listing on which the contract was initially based (the “root listing”) that is stored in the site inventory database 14. Similarly, changes made to the root listing will not be made automatically in the contract.

During the negotiations between the buyer and seller, either or both of the parties can navigate to the services page 22, or click on one of the services buttons 130 at the top of the negotiation able 28, to access outside services and consultants needed to complete the transaction. Referring to FIGS. 8, from services page 22 the user can click on “negotiation support services” button 209 to access a number of “negotiation support services” windows 210 that allow the user to send information online to providers of services such as financing, appraisal, shipping and engineering. When the user opens a window 210, the “buyer bio” and “seller bio” text fields 212 are automatically populated with information on the buyer and seller. The last posted version of the contract is automatically loaded into the “eContract” field 214. The user can then type text, e.g., instructions and requests, into text field 216, and send the completed request to the service provided by clicking on the send button 218.

Each party can choose to withhold its identity from the other party, or disclose its identity. If one party does not disclose its identity, the other party can send a request for such disclosure, by clicking on the “request ID” button 132, and the anonymous party can either comply, by clicking on the “turn on ID” button 134, or refuse, by clicking on the decline button 136.

If either or both of the parties wishes to have the posted contract reviewed by a third party, e.g., legal counsel or an engineering consultant, that party can click on the “preview eContract” button 138 to open the “eContract viewer” window 140. From this window, the user can print out the contract for review or to send a hard copy, or forward the document electronically by entering an email address in the “forward to” box 142. The seller can also print out or forward a saved copy of the contract that the seller has not yet posted. Also, either or both parties may issue an invitation to other users, e.g., legal counsel or engineering consultant, to join their team at any time. When the invited user responds to the invitation and joins the inviter's team, the eContract, its previous versions, and the discussion messages visible to that team will be visible to the invited third party.

Terminating Negotiations

As discussed above, at any stage in the negotiation an authorized user on the team of either of the parties can terminate the negotiation. Termination is the electronic version of, “walking away from the table.”

After clicking on the “terminate negotiation” button 126 or 129, the terminating party will be prompted to confirm that termination is desired. If the party confirms, then a message will be sent to the other party indicating that negotiations have been terminated. The parties can also enter into a termination dialog, e.g., discussing reasons for termination (see “termination dialog” windows 200 in FIG. 6A).

A copy of the terminated negotiation is archived, and is accessible to each party to the terminated negotiation. Terminated negotiations may be viewed by entering the user's account information page 21, and clicking on the appropriate listing in the “my terminated negotiations” box 202. If the user then desires to reopen negotiations, the user can click on “reactivate” button 204 in the “terminated negotiation viewer” window 206. Doing so will take the contract that had been under negotiation out of the archive, place the last posted contract in the parties' buy list and inventory index, and send a signal to the other party indicating a new negotiation.

Finalizing the Agreement

The seller cannot accept the contract prior to acceptance by the buyer. If, at any stage in negotiations, the buyer accepts the contract, the seller can then acknowledge the buyer's acceptance by clicking on box 144. The seller cannot edit the contract once the buyer has accepted—the seller must acknowledge the buyer's acceptance, terminate, or return to the negotiation.

Clicking on box 144 will activate the seller's semaphore in the “deal accepted” box 128. Once the seller has accepted, the transaction is completed and the contract is frozen. The contract may then be printed out and executed by the parties. No further changes may be made to the contract by either party. The final contract is archived in the user's databases of both parties, and may be accessed by entering the user's account information page 21 and clicking on the appropriate listing in the “my completed eContract archive” window 208. In some implementations, the message window dialogue will also be archived.

The invention may be implemented using an Oracle 8i Enterprise database cluster to store the information needed by the site server and IBM WebSphere as an application server running on the site server. Java servlets and Java server page functionality may be used on the site server. Development can be based on a standard model/view/controller framework.

Other embodiments are within the scope of the claims.

For example, while the invention has been discussed above in the context of purchase and sale transactions, the methods and systems of the invention can be used to facilitate other types of transactions, such as leases and licenses. Additionally, the methods and the systems of the invention can be used to facilitate complex negotiations that do not involve commercial transactions, e.g., the discussion and revision of a journal article by two parties, and allow the parties to the negotiation to archive their discussions, a final version of the document being discussed, and, if desired, some or all of the intermediate versions of the document.

Moreover, while the website application as described above does not allow the buyer to make changes to the contract, this is only the case for some implementations of the invention. The invention allows the initiating party to control whether or not the other party, or individual members of their own team, can obtain control of the write lock and therefore to modify the contract. Hence, other implementations may allow both parties, or the buyer only, to modify the contract.

Also, while transactions between buyers and sellers are discussed above, either party may be represented by a dealer, broker or other agent. Dealers, brokers, consultants or other types of agents can be invited to join a negotiation team and may be given editing rights like any other user.

Access to descriptions of possible transactions that are being offered on one Internet website may be made available to other websites. The access may be made through a database of documents maintained on the one website and an interface that enables the documents to be accessed by the other websites. The database containing documents pertaining to possible transactions includes an association between each item listing and one or more respondents, who may represent, for example, sales representatives or distributors covering different geographic regions or having other qualities of interest to the buyer. The database includes a separate association between each item listing and one or more document templates governing the different types of transactions such as purchases, leases or rentals of a given item listed. The user interested in a given listing is presented with a preferred subset of these possible choices for respondents or transactions depending on data already known to the system from the user profile, such as the user's geographic location or type of business, or based on solicitation of data through a series of interactive forms that guide the user to the most appropriate respondent and document template. In some cases, when a user initiates a negotiation the system may simply notify an authorized user of the system of the user's desire to negotiate, thus placing the seller in the role of initiating the negotiation. In other cases, users expressing interest in a given listing and initiating a negotiation may be given restricted privileges in the negotiation, such as not being allowed to create or modify document templates, nor to issue invitations to any individuals other than those associated with the specific listing. The initiation of a negotiation from a template initially populates the attributes of the document based on data about the user, the responder, or externally available information such as standard rate sheets, price lists, or external reference data such as indices of prevailing interest rates, commodity or equity prices. These different types of information such as the user profile, qualities of possible respondents, internal pricing or external reference data, may reside on a multiplicity of distributed databases.

What is claimed is:

1. A method comprising
enabling a first party to a possible transaction to invoke an element of a user interface to cause electronic mail invitations to be sent to selected individuals who will form a team representing the first party in connection with the transaction.

2. The method of claim 1 also including enabling the first party to invoke an element of a user interface to cause an electronic mail invitation to be sent to an administrator representing a second party to the transaction.

3. The method of claim 2 also including limiting permissions of the administrator with respect to interaction that will occur between the first party and the second party in connection with the transaction.

4. The method of claim 2 also including enabling the administrator to invoke an element of a user interface to invite additional individuals to form a team representing the second party in connection with the transaction.

5. A method comprising
enabling a user to identify a stored template as an initial draft of the text of a contract for use in connection with a possible transaction,
enabling two parties to modify the text of the contract as part of a negotiation with respect to the transaction, and
enabling the two parties to assent to a final version of the text of the contract as governing the transaction.

6. The method of claim 5 in which the template may be an empty contract, a copy of an existing contract from another transaction that has been stored as a template.

7. The method of claim 5 in which the contract comprises a full-text prose document organized in sections.

8. The method of claim 5 also including displaying to each of the parties any selected modification of the contract.

9. The method of claim 5 also including embedding attributes in the text of the agreement and enabling each of the parties to define global values for the attributes.

10. A method comprising
maintaining a draft text of a contract that represents a current state of a negotiation between two parties with respect to a transaction, and
maintaining a control mechanism that gives only one of the parties at a time a right to edit the draft text.

11. The method of claim 10 in which the control mechanism includes enabling a party that has the right to edit to relinquish the right to the other party.

12. The method of claim 11 also including displaying to both parties the status of the edit right.

13. The method of claim 10 in which at least one of the parties comprises a team of individuals, and the control mechanism gives only one of the individuals at a time the right to edit.

14. The method of claim 13 in which an individual who has the right to edit can relinquish it to another individual on his team or to the other party.

15. The method of claim 14 in which both of the parties comprise teams of individuals, and an individual who has the right to edit can relinquish the right to any other individual on either of the teams.

16. A method comprising
enabling a party to a possible transaction to form a team of individuals to participate in electronically negotiating terms of a contract with another party to the transaction,
identifying one of the individuals as an administrator of the team, and
enabling the administrator of the team to control the electronic participation of other individuals on the team in the negotiating.

17. The method of claim 16 in which controlling the electronic participation includes controlling the rights of the other individuals to view, edit, or approve the terms of the contract.

18. The method of claim 17 in which controlling the electronic participation includes controlling the rights of the other individuals to contribute electronic messages to the negotiation.

19. The method of claim 16 in which information about the team is stored electronically for later use in connection with another transaction.

20. The method of claim 16 in the administrator controls the membership of the team.

21. A method comprising
sending automatic electronic mail messages to parties engaged in an electronic negotiation of an agreement in connection with a transaction, the electronic mail messages providing notifications of state changes associated with the negotiation.

22. The method of claim 21 in which the state changes include changes to the agreement made since the electronic mail recipient's last viewing of the agreement.

23. The method of claim 21 in which the state changes include the existence of new posted messages with respect to the negotiation.

24. The method of claim 21 also including enabling an individual associated with one of the parties to control the volume of the electronic messages sent to him.

25. The method of claim 21 in which the volume of messages is controlled based on the type of state changes represented by the messages.

26. The method of claim 25 in which the type includes changes in the composition of a team associated with one of the parties, changes in the text of the agreement, the posting of messages, or changes in an approval status of the agreement.

27. An Internet website comprising
a database containing documents pertaining to possible transactions offered by customers of the website,
an interface that permits separate websites to access descriptions of the possible transactions and to direct interested users to the Internet website, and
a negotiation interface configured to allow the users to negotiate online to reach the terms of a transaction with the customers that offered the transactions.
